(19) United States
(12) Patent Application Publication
(10) Pub. No.: US 2016/0040105 A1
(43) Pub. Date: Feb. 11, 2016

(54) LAUNDRY DETERGENT COMPOSITION

(71) Applicant: The Procter & Gamble Company, Cincinnati, OH (US)

(72) Inventors: Karel Jozef Maria DEPOOT, Anzegem-Vichte (BE); Katrien Andrea Lieven VAN ELSEN, Puurs (BE)

(21) Appl. No.: 14/819,465

(22) Filed: Aug. 6, 2015

(30) Foreign Application Priority Data
Aug. 7, 2014 (EP) 14180173.8
Jul. 9, 2015 (EP) 15175999.0

(51) Int. Cl. C11D 17/04; C11D 1/83; C11D 1/66; C11D 3/50; C11D 1/22

(52) U.S. Cl. CPC C11D 17/043; C11D 3/505; C11D 1/22; C11D 1/66; C11D 1/83

(57) ABSTRACT

A water-soluble laundry unit dose article comprising a liquid composition, wherein said composition comprises;
an anionic surfactant;
an ethoxylated alcohol non-ionic surfactant;
water;
wherein the weight ratio of total anionic: non-ionic is between 5:1 and 23:1; and
wherein the composition comprises between 0.1 wt % and 5 wt % of a perfume and
between 0.1 wt % and 5 wt % of an encapsulated perfume.

### FIELD OF THE INVENTION

Laundry detergent composition comprising freshness active.

### BACKGROUND OF THE INVENTION

Laundry unit dose articles have become very popular with the consumer. Such articles are usually constructed of one or more water-soluble films shaped to provide at least one internal compartment. Contained within the internal compartment is a laundry detergent composition. Upon addition to water, the water-soluble film dissolves releasing the composition in to the wash liquor.

Freshness actives are known to provide benefits in laundry detergent compositions. Often such freshness actives are in the form of perfumes or encapsulated perfumes. An issue with freshness actives is that a lot of the material tends to be lost during the wash process since it does not deposit on the fabrics and is subsequently washed away with the wash liquor. Therefore, large concentrations of freshness actives need to be added to the wash liquor to achieve the desired deposition onto the fabrics.

In the case of water-soluble unit dose articles, there is a restriction on how much material can be formulated into the article. This is due to a physical size constraint of the unit dose article. Therefore, it is often difficult to achieve a desired scent experience on the laundered fabrics in lieu of the concentration of freshness materials achieved in the unit dose article. Increasing the concentration of freshness materials in the unit dose article is at the expense of other materials present, often negatively impacting the fabric cleaning experience.

There is a need in the art for an improved freshness/scent experience on fabrics laundered with a water-soluble unit dose article whilst still maintaining excellent cleaning.

The Inventors surprisingly found that deposition of freshness actives on to fabrics during the wash cycle could be improved by carefully controlling the ratio of freshness actives, anionic surfactant and non-ionic surfactant in the detergent composition.

### SUMMARY OF THE INVENTION

The present invention is to a water-soluble laundry unit dose article comprising a liquid composition, wherein said composition comprises;
an anionic surfactant;
an ethoxylated alcohol non-ionic surfactant;
water;
wherein the weight ratio of total anionic: non-ionic is between 5:1 and 23:1; and
wherein the composition comprises between 0.1 wt % and 5 wt % of a perfume and between 0.1 wt % and 5 wt % of an encapsulated perfume.

### DETAILED DESCRIPTION OF THE INVENTION

### Water-Soluble Laundry Unit Dose Article

The water-soluble unit dose article comprises a water-soluble film and a liquid composition. The water-soluble film and liquid laundry detergent composition are described in more detail below.

The unit dose article herein is typically a closed structure, made of the water-soluble film enclosing an internal volume which comprises the liquid composition.

The unit dose article can be used as a fully formulated consumer product, or may be added to one or more further ingredient to form a fully formulated consumer product. The unit dose article may be a ‘pre-treat’ composition which is added to a fabric, preferably a fabric stain, ahead of the fabric being added to a wash liquor. The unit dose article can be used in a fabric hand wash operation or may be used in an automatic machine fabric wash operation.

The volume of the liquid laundry detergent composition within the unit dose article maybe between 10 ml and 30 ml, preferably between 10 ml and 23 ml, preferably between 10 ml and 20 ml. Without wishing to be bound by theory, it was found that by carefully regulating the volume, the unit dose article was less likely to become trapped between the door and the seal, or within the seal itself of an automatic laundry washing machine.

The unit dose article may have a weight of less than 35 g, or even between 10 g and 28 g, or even between 10 g and 25 g. Without wishing to be bound by theory, it was found that by carefully regulating the weight, the unit dose article was less likely to become trapped between the door and the seal, or within the seal itself of an automatic laundry washing machine.

The unit dose article may comprise a gas, and wherein the ratio of the volume of said gas to the volume of the liquid laundry detergent composition is between 1:4 and 1:20, or even between 1:5 and 1:15, or even between 1:5 and 1:9.

The water-soluble unit dose article may comprise multiple compartments. The unit dose article may comprise two, or three, or four or five compartments.

At least one compartment comprises a composition. Each compartment may comprise the same or a different composition. The unit dose article comprises a liquid composition, however, it may also comprise different compositions in different compartments. The composition may be a solid, liquid, gel, fluid, dispersion or a mixture thereof.

The water-soluble film is shaped such that it defines the shape of the compartment, such that the compartment is completely surrounded by the film. The compartment may be formed from a single film, or multiple films. For example the compartment may be formed from two films which are sealed together (e.g. heat sealed, solvent sealed or a combination thereof). The water-soluble film is sealed such that the composition does not leak out of the compartment during storage. However, upon addition of the water-soluble pouch to water, the water-soluble film dissolves and releases the contents of the internal compartment into the wash liquor.

The water-soluble unit dose article can be of any form, shape and material which is suitable for holding the composition, i.e. without allowing the release of the composition, and any additional component, from the unit dose article prior to contact of the unit dose article with water. The exact execution will depend, for example, on the type and amount of the compositions in the unit dose article. The unit dose article may have a substantially, square, rectangular, oval, elliptoid, superelliptical, or circular shape. The shape may or may not include any excess material present as a flange or skirt at the point where two or more films are sealed together. By substantially, we herein mean that the shape has an overall impression of being for example square. It may have rounded corners and/or non-straight sides, but overall it gives the impression of being square for example.

A multi-compartment unit dose article form may be desirable for such reasons as: separating chemically incompatible ingredients; or where it is desirable for a portion of the ingredients to be released into the wash earlier or later.

The multiple compartments may be arranged in any suitable orientation. For example the unit dose article may comprise a bottom compartment, and at least a first top compartment, wherein the top compartment is superposed onto the bottom compartment. The unit dose article may comprise a bottom compartment and at least a first and a second top compartment, wherein the top compartments are arranged side-by-side and are superposed on the bottom compartment; preferably, wherein the article comprises a bottom compartment and at least a first, a second and a third top compartment, wherein the top compartments are arranged side-by-side and are superposed on the bottom compartment.

Alternatively, the compartments may all be positioned in a side-by-side arrangement. In such an arrangement the compartments may be connected to one another and share a dividing wall, or may be substantially separated and simple held together by a connector or bridge. Alternatively, the compartments may be arranged in a ‘tyre and rim’ orientation, i.e. a first compartment is positioned next to a second compartment, but the first compartment at least partially surrounds the second compartment, but does not completely enclose the second compartment. The unit dose article may comprise two compartments, wherein a first compartment comprises from 5% and 20% by weight of the compartment of a chelant, preferably wherein the chelant is in a solid form.

Preferably, the unit dose article ruptures between 10 seconds and 5 minutes once the unit dose article has been added to 950 ml of deionised water at 20-21° C. in a 1L beaker, wherein the water is stirred at 350 rpm with a 5 cm magnetic stirrer bar. By rupture, we herein mean the film is seen to visibly break or split. Shortly after the film breaks or splits the internal liquid detergent composition may be seen to exit the unit dose article into the surrounding water.

It is an object of the present invention to provide an improved freshness/scent experience on fabrics laundered with a water-soluble unit dose article whilst still maintaining excellent cleaning. It is a further object of the present invention to provide an improved freshness/scent experience on fabrics laundered with a water-soluble unit dose article whilst also providing improved cleaning.

### Water-Soluble Film

The film of the unit dose article is soluble or dispersible in water, and preferably has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated water straight from the tap. Preferably such films exhibit good dissolution at temperatures below 25° C., more preferably below 21° C., more preferably below 15° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310, films described in U.S. Pat. No. 6,166,117 and U.S. Pat. No. 6,787,512 and PVA films of corresponding solubility and deformability characteristics. Further preferred films are those describes in US2006/0213801, WO 2010/119022, US2011/0188784 and U.S. Pat. No. 6,787,512.

Preferred water soluble films are those resins comprising one or more PYA polymers, preferably said water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 cP (cP mean centipoise), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP, Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20. deg. C. All viscosities specified herein in cP should be understood to refer to the viscosity of 4% aqueous polyvinyl alcohol solution at 20. deg. C, unless specified otherwise. Similarly, when a resin is described as having (or not having) a particular viscosity, unless specified otherwise, it is intended that the specified viscosity is the avergize viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

The PVA resin can still further include one or more additional PVA polymers that have a viscosity in a range of about 10 to about 40 cP and a degree of hydrolysis in a range of about 84% to about 92%.

When the PVA resin includes a first PVA polymer having an average viscosity less than about 11 cP and a polydispersity index in a range of about L8 to about 2.3, then in one type of embodiment the PVA resin contains less than about 30 wt. % of the first PVA polymer, Similarly, when the PVA resin includes a first PVA polymer having an average viscosity less than about 11 cP and a polydispersity index in a range of about 1.8 to about 2.3, then in another, non-exclusive type of embodiment the PVA resin contains less than about 30 wt. % of a PVA polymer having a Mw less than about 70,000 Daltons.

Of the total PVA resin content in the film described herein, the PVA resin can comprise about 30 to about 85 wt. % of the first PVA polymer, or about 45 to about 55 wt. % of the first PVA polymer. For example, the PVA resin can contain about 50 wt. % of each PVA polymer, wherein the viscosity of the first PVA polymer is about 13 cP and the viscosity of the second PVA polymer is about 23 cP.

One type of embodiment is characterized by the PVA resin including about 40 to about 85 wt. % of a first PVA polymer that has a viscosity in a range of about 10 to about 15 cP and a degree of hydrolysis in a range of about 84% to about 92%. Another type of embodiment is characterized by the PVA resin including about 45 to about 55 wt. % of the first PVA polymer that has a viscosity in a range of about 10 to about 15 cP and a degree of hydrolysis in a range of about 84% to about 92%. The PVA resin can include about 15 to about 60 wt. % of the second PVA polymer that has a viscosity in a range of about 20 to about 25 el' and a degree of hydrolysis in a range of about 84% to about 92%, One contemplated class of embodiments is characterized by the PVA resin including about 45 to about 55 wt. % of the second PVA polymer.

When the PVA resin includes a plurality of PVA polymers the PDI value of the PVA resin is greater than the PDI value of any individual, included PVA polymer. Optionally, the PDI value of the PVA resin is greater than 2.2, 2.3, 2.4, 2.5, 2.6 2.7, 2.8, 2.9, 3.0, 3.1, 3.2, 3.3, 3.4, 3.5, 3.6, 3.7, 3.8, 3.9, 4.0, 4.5, or 5.0.

Preferably the PVA resin has a weighted, average degree of hydrolysis ( H̅°̅) between about 80 and about 92%, or between about 83 and about 90%, or about 85 and 89%. For example, H̅°̅ for a PVA resin that comprises two or more PVA polymers is calculated by the formula H̅°̅=Σ(wi·Hᵢ) where W₁ is the weight percentage of the respective PVA polymer and a Hᵢ is the respective degrees of hydrolysis. Still further it is desirable to choose a PVA resin that has a weighted log viscosity ( μ̅) between about 10 and about 25, or between about 12 and 22, or between about 13.5 and about 20. The μ̅ for a PVA resin that comprises two or more PVA polymers is calculated by the formula μ̅=e^{ΣW}^{ᵢ}^{·lnμ}^{ᵢ} where ∥ᵢ is the viscosity for the respective PVA polymers.

Yet further, it is desirable to choose a PVA resin that has a Resin Selection Index (RSI) in a range of 0.255 to 0.315, or 0.260 to 0.310, or 0.265 to 0.305, or 0.270 to 0.300, or 0.275 to 0.295, preferably 0.270 to 0.300. The RSI is calculated by the formula; Σ(wᵢ|μᵢ−μᵢ|)/Σ(wᵢμᵢ), wherein μᵢ is seventeen, μᵢ is the average viscosity each of the respective PVOH polymers, and Wᵢ is the weight percentage of the respective PVOH polymers.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including water, to be delivered to the wash water, for example organic polymeric dispersants, etc.

The film may be lactone free. By this we mean that the film does not comprise any lactone. Alternatively, the film may comprise very low levels of lactone that are present due to impurities but which have not been deliberately added. However, essentially the film will be free of lactone.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000ppm, or even 100 to 2500ppm, or even 250 to 2000 rpm.

### Liquid Composition

The composition of the present invention is preferably a liquid laundry detergent composition. The term ‘liquid laundry detergent composition’ refers to any laundry detergent composition comprising a fluid capable of wetting and treating fabric e.g., cleaning clothing in a domestic washing machine, and includes, but is not limited to, liquids, gels, pastes, dispersions and the like. The liquid composition can include solids or gases in suitably subdivided form, but the liquid composition excludes forms which are non-fluid overall, such as tablets or granules.

The liquid composition comprises an anionic surfactant, wherein the anionic surfactant preferably comprises linear alkylbenzene sulphonate.

The liquid composition comprises an ethoxylated alcohol non-ionic surfactant.

The liquid composition comprises water.

The weight ratio of total anionic surfactant (i.e. all anionic surfactant present in the liquid composition) : non-ionic in the liquid composition is between 5:1 and 23:1. Suitable anionic surfactants are described in more detail below.

The liquid composition comprises between 0.1 wt % and 5 wt % of a perfume and between 0.1 wt % and 5 wt % of an encapsulated perfume. The liquid composition may comprise between 0.1 wt % and 5 wt % of a perfume and an encapsulated perfume. Suitable perfume materials and encapusulated perfumes are described in more detail below.

The composition may have a pH of from 6-12, preferably from 7-9.

### Perfume and Encapsulated Perfume

Any suitable perfume or encapsulated perfume may be used. Perfumes usually comprise different mixtures of perfume raw materials. The type and quantity of perfume raw material dictates the olfactory character of the perfume.

The perfume may comprise a perfume raw material selected from the group consisting of perfume raw materials having a boiling point (B.P.) lower than about 250° C. and a ClogP lower than about 3, perfume raw materials having a B.P. of greater than about 250° C. and a ClogP of greater than about 3, perfume raw materials having a B.P. of greater than about 250° C. and a ClogP lower than about 3, perfume raw materials having a B.P. lower than about 250° C. and a ClogP greater than about 3 and mixtures thereof. Perfume raw materials having a boiling point B.P. lower than about 250° C. and a ClogP lower than about 3 are known as Quadrant I perfume raw materials. Quadrant 1 perfume raw materials are preferably limited to less than 30% of the perfume comprosition. Perfume raw materials having a B.P. of greater than about 250° C. and a ClogP of greater than about 3 are known as Quadrant IV perfume raw materials, perfume raw materials having a B.P. of greater than about 250° C. and a ClogP lower than about 3 are known as Quadrant II perfume raw materials, perfume raw materials having a B.P. lower than about 250° C. and a ClogP greater than about 3 are known as a Quadrant III perfume raw materials. Suitable Quadrant I, II, III and IV perfume raw materials are disclosed in U.S. Pat. No. 6,869,923 B1.

Preferred perfume raw material classes include ketones and aldehydes. Those skilled in the art will know how to formulate an appropriate perfume.

Any suitable encapsulated perfume may be used. Preferred encapsulated perfumes are perfume microcapsules, preferably of the core-and-shell architecture. Such perfume microcapsules comprise an outer shell defining an inner space in which the perfume is held until rupture of the perfume microcapsule during use of the fabrics by the consumer.

The microcapsule preferably comprises a core material and a wall material that at least partially surrounds said core, wherein said core comprises the perfume.

In one aspect, at least 75%, 85% or even 90% of said microcapsules may have a particle size of from about 1 microns to about 80 microns, about 5 microns to 60 microns, from about 10 microns to about 50 microns, or even from about 15 microns to about 40 microns. In another aspect, at least 75%, 85% or even 90% of said microcapsules may have a particle wall thickness of from about 60 nm to about 250 nm, from about 80 nm to about 180 nm, or even from about 100 nm to about 160 nm.

In one aspect, said perfume delivery technology may comprise microcapsules formed by at least partially surrounding a benefit agent with a wall material. Said benefit agent may include materials selected from the group consisting of perfumes such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, α-damascone, β-damascone, δ-damascone, β-damascenone, 6,7-dihydro-1,1,2,3,3-pentamethyl-4(5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and β-dihydro ionone, linalool, ethyllinalool, tetrahydrolinalool, and dihydromyrcenol; silicone oils, waxes such as polyethylene waxes; essential oils such as fish oils, jasmine, camphor, lavender; skin coolants such as menthol, methyl lactate; vitamins such as Vitamin A and E; sunscreens; glycerine; catalysts such as manganese catalysts or bleach catalysts; bleach particles such as perborates; silicon dioxide particles; antiperspirant actives; cationic polymers and mixtures thereof. Suitable benefit agents can be obtained from Givaudan Corp. of Mount Olive, N.J., USA, International Flavors & Fragrances Corp. of South Brunswick, N.J., USA, or Quest Corp. of Naarden, Netherlands. In one aspect, the microcapsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol and mixtures thereof. In one aspect, said melamine wall material may comprise melamine crosslinked with formaldehyde, melamine-dimethoxyethanol crosslinked with formaldehyde, and mixtures thereof. In one aspect, said polystyrene wall material may comprise polyestyrene cross-linked with divinylbenzene. In one aspect, said polyurea wall material may comprise urea crosslinked with formaldehyde, urea crosslinked with gluteraldehyde, and mixtures thereof. In one aspect, said polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

In one aspect, said polyacrylate ester based wall materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

In one aspect, said aromatic alcohol based wall material may comprise aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresoles (o-, and p-cresol), naphthols (alpha and beta -naphthol) and thymol, as well as ethylphenols, propylphenols, fluorphenois and methoxyphenols.

In one aspect, said polyurea based wall material may comprise a polyisocyanate. In some embodiments, the polyisocyanate is an aromatic polyisocyanate containing a phenyl, a toluoyl, xylyl, a naphthyl or a diphenyl moiety (e.g., a polyisocyanurate of toluene diisocyanate, a trimethylol propane-adduct of toluene diisocyanate or a trimethylol propane-adduct of xylylene diisocyanate), an aliphatic polyisocyanate (e.g., a trimer of hexamethylene diisocyanate, a trimer of isophorone diisocyanate and a biuret of hexamethylene diisocyanate), or a mixture thereof (e.g., a mixture of a biuret of hexamethylene diisocyanate and a trimethylol propane-adduct of xylylene diisocyanate). In still other embodiments, the polyisocyante may be cuss-linked, the cross-linking agent being a polyamine (e.g., diethylenetriamine, bis(3-aminopropyl)amine, bis(hexanethylene)triamine, tris(2-aminoethyl)amine, triethylenetetramine, N,N′-bis(3-aminopropyl)-1,3-propanediamine, tetraethylenepentamine, pentaethylenehexamine, branched polyethylenimine, chitosan, nisin, gelatin, 1,3-diaminoguanidine monohydrochloride, 1,1-dimethylbiguanide hydrochloride, or guanidine carbonate).

In one aspect, said polyvinyl alcohol based wall material may comprise a crosslinked, hydrophobically modified polyvinyl alcohol, which comprises a crosslinking agent comprising a first dextran aldehyde having a molecular weight of from 2,000 to 50,000 Da; and ii) a second dextran aldehyde having a molecular weight of from greater than 50,000 to 2,000,000 Da.

In one aspect, the perfume microcapsule may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, and combinations thereof. Suitable deposition aids are described above and in the section titled “Deposition Aid”. In one aspect, the microcapsule may be a perfume microcapsule. In one aspect, one or more types of microcapsules, for examples two microcapsules types, wherein one of the first or second microcapsules (a) has a wall made of a different wall material than the other; (b) has a wall that includes a different amount of wail material or monomer than the other; or (c) contains a different amount perfume oil ingredient than the other.; or (d) contains a different perfume oil, may be used.

### Anionic Surfactant

The anionic surfactant may be selected from linear alkyl benzene sulfonate, alkyl ethoxylate sulphate and combinations thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Exemplary anionic surfactants are the alkali metal salts of C₁₀-C₁₆ alkyl benzene sulfonic acids, or C₁₁-C₁₄ alkyl benzene sulfonic acids. In one aspect, the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially useful are the sodium, potassium and amine linear straight chain alkylbenzene sulfonates in which the average number of carbon atoms in the alkyl group is from about 11 to 14. Sodium C₁₁-C₁₄, e.g., C₁₂, LAS is a specific example of such surfactants.

Specific, non-limiting examples of anionic surfactants useful herein include the acid or salt forms of: a) C₁₁-C₁₈ alkyl benzene sulfonates (LAS); b) C₁₀-C₂₀ primary, branched-chain and random alkyl sulfates (AS), including predominantly C₁₂ alkyl sulfates; c) C₁₀-C₁₈ secondary (2,3) alkyl sulfates with non-limiting examples of suitable cations including sodium, potassium, ammonium, amine and mixtures thereof; d) C₁₀-C₁₈ alkyl alkoxy sulfates (AEₓS) wherein x is from 1-30; e) C₁₀-C₁₈ alkyl alkoxy carboxylates in one aspect, comprising 1-5 ethoxy units; f) mid-chain branched alkyl sulfates as discussed in U.S. Pat. No. 6,020,303 and U.S. Pat. No. 6,060,443; g) mid-chain branched alkyl alkoxy sulfates as discussed in U.S. Pat. No. 6,008,181 and U.S. Pat. No. 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (MES); and j) alpha-olefin sulfonate (AOS).

A suitable anionic detersive surfactant is predominantly alkyl C₁₆ alkyl mid-chain branched sulphate. A suitable feedstock for predominantly alkyl C₁₆ alkyl mid-chain branched sulphate is beta-farnesene, such as BioFene™ supplied by Amyris, Emeryville, Calif.

The anionic surfactant may comprise a fatty acid or fatty acid salts. The fatty acids are preferably carboxylic acids which are often with a long unbranched aliphatic tail, which is either saturated or unsaturated. Suitable fatty acids include ethoxylated fatty acids. Suitable fatty acids or salts of the fatty acids for the present invention are preferably sodium salts, preferably C12-C18 saturated and/or unsaturated fatty acids more preferably C12-C14 saturated and/or unsaturated fatty acids and alkali or alkali earth metal carbonates preferably sodium carbonate.

Preferably the fatty acids are selected from the group consisting of lauric acid, myristic acid, palmitic acid, stearic acid, topped palm kernel fatty acid, coconut fatty acid and mixtures thereof.

The liquid composition may comprise between 20 and 60 wt %, or even between 25 and 50 wt % or even between 30 and 40 wt % anionic surfactant.

The liquid composition may comprise between 15 wt % and 25 wt % linear alkybenzene sulphonate.

### Non-Ionic Surfactant

Suitable nonionic surfactants useful herein can comprise any of the conventional nonionic surfactant types typically used in liquid detergent products. These include alkoxylated fatty primary alcohol-based or secondary alcohol-based surfactants and amine oxide surfactants. In one aspect, for use in the liquid detergent products herein are those nonionic surfactants which are normally liquid.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. In one aspect, R¹ is an alkyl group, which may be primary or secondary, that comprises from about 9 to 15 carbon atoms, or from about 10 to 14 carbon atoms. In one aspect, the alkoxylated fatty alcohols will also be ethoxylated materials that contain from about 2 to 12 ethylene oxide moieties per molecule, or from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17 from about 6 to 15, or from about 8 to 15. Alkoxylated fatty alcohol nonionic surfactants have been marketed under the tradenames Neodol and Dobanol by the Shell Chemical Company.

Suitable non-ionic surfactants can include ethoxylated nonionic surfactants, which may include primary and secondary alcohol ethoxylates, especially the C₈-C₂₀ aliphatic alcohols ethoxylated with an average of from 1 to 50 or even 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated alcohol nonionic surfactants include alkylpolyglycosides, glycerol monoethers, and polyhydroxyamides (glucamide), glycereth cocoate.

The ethoxylated alcohol non-ionic surfactant can be, for example, a condensation product of from 3 to 8 mol of ethylene oxide with 1 mol of a primary alcohol having from 9 to 15 carbon atoms.

The non-ionic surfactant may comprise a fatty alcohol ethoxylate of formula R(EO)ₙ, wherein R represents an alkyl chain between 4 and 30 carbon atoms, (EO) represents one unit of ethylene oxide monomer and n has an average value between 0.5 and 20.

Another suitable type of nonionic surfactant useful herein comprises the amine oxide surfactants. Amine oxides are materials which are often referred to in the art as “semi-polar” nonionics. Amine oxides have the formula: R(EO)ₓ(PO)_{y}(BO)_{z}N(O)(CH₂R′)₂.qH₂O. In this formula, R is a relatively long-chain hydrocarbyl moiety which can be saturated or unsaturated, linear or branched, and can contain from 8 to 20, 10 to 16 carbon atoms, or is a C₁₂-C₁₆ primary alkyl. R′ is a short-chain moiety, in one aspect R′ may be selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Non-limiting examples of nonionic surfactants include: a) C₁₂-C₁₈ alkyl ethoxylates, such as, NEODOL® nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as Pluronic® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x if from 1-30, as discussed in U.S. Pat. No. 6,153,577, U.S. Pat. No. 6,020,303 and U.S. Pat. No. 6,093,856; f) Alkylpolysaccharides as discussed in U.S. Pat. No. 4,565,647 to Leandro, issued Jan. 26, 1986; specifically alkylpolyglycosides as discussed in U.S. Pat. No. 4,483,780 and U.S. Pat. No. 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

The composition may comprise between 0.5 wt % and 7.5 wt %, or even between lwt% and 5 wt % non-ionic surfactant.

### Cationic Polymer

The unit dose article may comprise a cationic polymer. The cationic polymer is a hydroxyethyl cellulose polymer. Preferably, the hydroxyethyl cellulose polymer is derivatised with trimethyl ammonium substituted epoxide. The polymer may have a molecular weight of between 100,000 and 800,000 daltons.

Preferred cationic cellulose polymers for use herein include those which may or may not be hydrophobically-modified, including those having hydrophobic substituent groups, having a molecular weight of from 100,000 to 800,000. These cationic polymers have repeating substituted anhydroglucose units that correspond to the general Structural Formula I as follows:

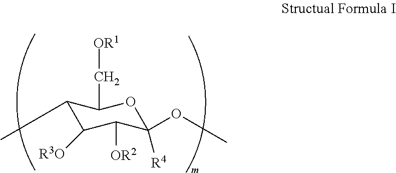

wherein:
a. m is an integer from 20 to 10,000
b. Each R4 is H, and R¹, R², R³ are each independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, and

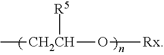

Preferably, R¹, R², R³ are each independently selected from the group consisting of: H; C₁-C₄ alkyl;

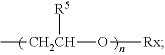

and mixtures thereof;
wherein:

n is an integer selected from 0 to 10 and

Rx is selected from the group consisting of: R₅;

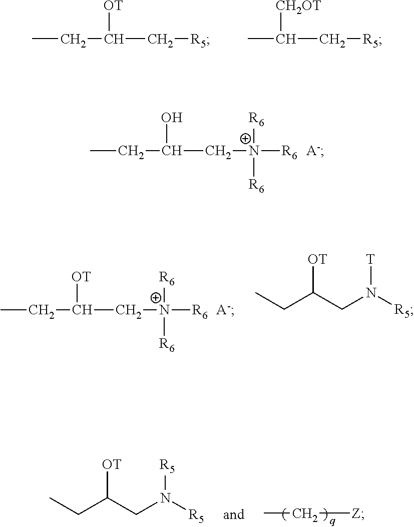

wherein said polysaccharide comprises at least one Rx, and said Rx has a structure selected from the group consisting of:

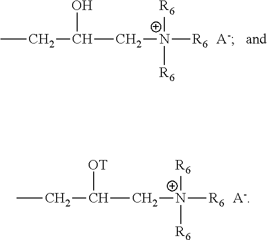

wherein A⁻ is a suitable anion. Preferably, A⁻ is selected from the group consisting of: Cl⁻, Br⁻, I⁻, methylsulfate, ethylsulfate, toluene sulfonate, carboxylate, and phosphate;

Z is selected from the group consisting of carboxylate, phosphate, phosphonate, and sulfate.

q is an integer selected from 1 to 4;

each R₅ is independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, and OH. Preferably, each R₅ is selected from the group consisting of: H, C₁-C₃₂ alkyl, and C₁-C₃₂ substituted alkyl. More preferably, R₅ is selected from the group consisting of H, methyl, and ethyl.

Each R₆ is independently selected from the group consisting of: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl. Preferably, each R₆ is selected from the group consisting of: H, C₁-C₃₂ alkyl, and C₁-C₃₂ substituted alkyl.

Each T is independently selected from the group:

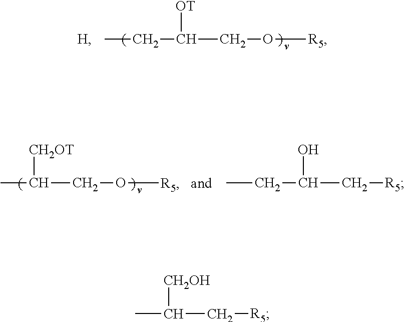

wherein each v in said polysaccharide is an integer from 1 to 10. Preferably, v is an integer from 1 to 5. The sum of all v indices in each Rx in said polysaccharide is an integer from 1 to 30, more preferably from 1 to 20, even more preferably from 1 to 10. In the last

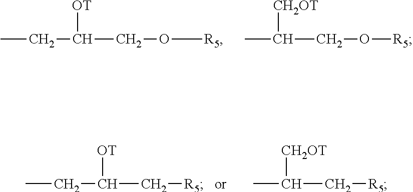

group in a chain, T is always an H.

Alkyl substitution on the anhydroglucose rings of the polymer may range from 0.01% to 5% per glucose unit, more preferably from 0.05% to 2% per glucose unit, of the polymeric material.

The cationic cellulose may be lightly cross-linked with a dialdehyde, such as glyoxal, to prevent forming lumps, nodules or other agglomerations when added to water at ambient temperatures.

The cationic cellulose polymers of Structural Formula I likewise include those which are commercially available and further include materials which can be prepared by conventional chemical modification of commercially available materials. Commercially available cellulose polymers of the Structural Formula I type include those with the INCI name Polyquaternium 10, such as those sold under the trade names: Ucare Polymer JR 30M, JR 400, JR 125, LR 400 and LK 400 polymers; Polyquaternium 67 such as those sold under the trade name Softcat SK™, all of which are marketed by Amerchol Corporation, Edgewater N.J.; and Polyquaternium 4 such as those sold under the trade name: Celquat H200 and Celquat L-200, available from National Starch and Chemical Company, Bridgewater, N.J. Other suitable polysaccharides include hydroxyethyl cellulose or hydoxypropylcellulose quaternized with glycidyl C₁₂-C₂₂ alkyl dimethyl ammonium chloride. Examples of such polysaccharides include the polymers with the INCI names Polyquaternium 24 such as those sold under the trade name Quaternium LM 200 by Amerchol Corporation, Edgewater N.J. Cationic starches described by D. B. Solarek in Modified Starches, Properties and Uses published by CRC Press (1986) and in U.S. Pat. No. 7,135,451, col. 2, line 33-col. 4, line 67.

The hydroxyethyl cellulose polymer may be added to the composition as a particle. It may be present in the composition of the particle or may be also be present as a liquid, or a mixture thereof.

Without wishing to be bound by theory, hydroxyethyl cellulose polymers provide fabric softening benefits. It was surprisingly found that the composition of the present invention when comprising an hydroxyethyl cellulose exhibited improved softening benefit as compared to compositions outside of the scope of the present invention.

### Adjunct Ingredients

The unit dose article may comprise an adjunct ingredient. The adjunct laundry detergent ingredient may be selected from bleach, bleach catalyst, dye, hueing agents, cleaning polymers, alkoxylated polyamines, polyethyleneimines, alkoxylated polyethyleneimines, soil release polymers, amphiphilic graft polymers, surfactants, solvents, dye transfer inhibitors, chelants, enzymes, perfumes, encapsulated perfumes, perfume delivery agents, suds suppressor, brighteners, polycarboxylates, structurants, anti-oxidants, deposition aids and mixtures thereof.
Hueing dye: The liquid laundry detergent composition may comprise a hueing dye. The hueing dyes employed in the present laundry care compositions may comprise polymeric or non-polymeric dyes, pigments, or mixtures thereof. Preferably the hueing dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred.

The hueing dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.
Chelant: The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein. Suitable chelants may be selected from: diethylene triamine pentaacetate, diethylene triamine penta(methyl phosphonic acid), ethylene diamine-N′, N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The laundry detergent composition may comprise ethylene diamine-N′N′-disuccinic acid or salt thereof. The ethylene diamine-N′N′-disuccinic acid may be in S,S enantiomeric form. The composition may comprise 4,5-dihydroxy-m-benzenedisulfonic acid disodium salt, glutamic acid-N,N-diacetic acid (GLDA) and/or salts thereof, 2-hydroxypyridine-1-oxide, Triton P™ from BASF, Ludwigshafen, Germany. Suitable chelants may also be calcium carbonate crystal growth inhibitors. Suitable calcium carbonate crystal growth inhibitors may be selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.
Polymers: Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.
Enzymes: The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, B-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.
Solvent: The composition may comprise a solvent. The solvent preferably has molecular weight of less than 1500, more preferably less than 1000, even more preferably less than 700, even less than 500. The solvent preferably has a molecular weight of greater than 10.

The solvent may be selected from alcohols, diols, monoamine derivatives, glycols, polyalkylane glycols, such as polyethylene glycol, propane diol, monoethanolamine or mixtures thereof.

The solvent may be selected from the group comprising of polyethylene glycol (PEG) polymer having molecular weight between 300 and 600, dipropylene glycol (DPG), nbutoxy propoxy propanol (nBPP) and mixtures thereof. More preferably the solvent may be selected from the group comprising polyethylene glycol (PEG) polymer having molecular weight between 400 and 600, dipropylene glycol (DPG), nbutoxy propoxy propanol (nBPP), polypropylene glycol (PPG) and mixtures thereof.
Structurant: The composition may comprise a structurant. Any suitable structurant may be used, however hydrogenated castor oil structurants such as commercially available Thixcin are preferred.
The structurant may be a non-polymeric structurant, preferably a crystallisable glyceride. The structurant may be a polymeric structurant, preferably a fibre based polymeric structurant, more preferably a cellulose based fibre-based structurant.

Other polymeric structurants are selected from the group consisting of: hydrophobically-modified ethoxylated urethanes (HEUR); hydrophobically modified alkali swellable emulsion (HASE), and mixtures thereof.
Suds suppressor: The composition may comprise a suds suppressor, preferably a siloxane-based polymer suds suppressor (herein also referred to simply as ‘suds suppressor’). The suds suppressor may be an organomodified siloxane polymer. The organomodified siloxane polymers may comprise aryl or alkylaryl substituents optionally combined with silicone resin and/or modified silica. In one embodiment, the suds suppressor is selected from organomodified silicone polymers with aryl or alkylaryl substituents combined with silicone resin and optionally a primary filler. Particularly preferred are silicone suds suppressor compounds consisting of organomodified silicone polymers with aryl or alkyaryl substituents combined with silicone resin and modified silica as described in U.S. Pat. Nos. 6,521,586 B1, 6,521,587 B1, US Patent Applications 2005 0239908 A1, 2007 01673 A1 to Dow Corning Corp. and US Patent Application 2008 0021152 A1 to Wacker Chemie AG.
Anti-oxidant: The liquid laundry detergent composition may comprise an anti-oxidant. The antioxidant is preferably selected from the group consisting of butylated hydroxyl toluene (BHT), butylated hydroxyl anisole (BHA), trimethoxy benzoic acid (TMBA), α, β, λ and δ tocophenol (vitamin E acetate), 6 hydroxy-2,5,7,8-tetra-methylchroman-2-carboxylic acid (trolox), 1,2, benzisothiazoline-3-one (proxel GLX), tannic acid, galic acid, Tinoguard AO-6, Tinoguard TS, ascorbic acid, alkylated phenol, ethoxyquine 2,2,4 trimethyl, 1-2-dihydroquinoline, 2,6 di or tert or butyl hydroquinone, tert, butyl, hydroxyl anisole, lignosulphonic acid and salts thereof, benzofuran, benzopyran, tocopherol sorbate, butylated hydroxyl benzoic acid and salts thereof, galic acid and its alkyl esters, uric acid, salts thereof and alkyl esters, sorbic acid and salts thereof, dihydroxy fumaric acid and salts thereof, and mixtures thereof. Preferred antioxidants are those selected from the group consisting of alkali and alkali earth metal sulfites and hydrosulfites, more preferably sodium sulfite or hydrosulfite.
Water: The liquid laundry detergent composition may comprise between 0.5 and 50 wt % water, or even between 0.5 and 25 wt % water or even between land 15 wt % water.
The liquid laundry detergent composition may comprise less than 50%, or even less than 40% or even less than 30% by weight of water. The liquid laundry detergent composition may comprise from 1% to 30%, or even from 2% to 20% or even from 3% to 15% by weight of the composition of water.

### Process of Making

Any suitable process can be used to make the composition of the present invention. Those skilled in the art will know suitable process known the art.

### Method of Use

The unit dose article of the present invention can be added to a wash liquor to which h laundry is already present, or to which laundry is added. It may be used in an automatic washing machine operation and added directly to the drum or to the dispenser drawer. It may be used in combination with other laundry detergent compositions such as fabric softeners or stain removers. It may be used as pre-treat composition on a stain prior to being added to a wash liquor.

### EXAMPLES

### Example 1

Below are liquid detergent compositions with different surfactant compositions. Example B, C, E, F & G are part of the invention, whereas example A & D are outside of the scope of the present invention.

| Ingredients (All levels are | | | | | | | |
|---|---|---|---|---|---|---|---|
| in weight percent of the | | | | | | | |
| composition.) | A | B | C | D | E | F | G |
| Linear C₉-C₁₅ | 18.3 | 20.5 | 26.6 | 18.3 | 20.5 | 26.6 | 11.5 |
| Alkylbenzene | | | | | | | |
| sulfonic acid | | | | | | | |
| C12-14 alkyl ethoxy 3 | 5.7 | 13.7 | 7.6 | 5.7 | 13.7 | 7.6 | 22.9 |
| sulfate | | | | | | | |
| C₁₂₋₁₄ alkyl 7-ethoxylate | 13.9 | 3.9 | 3.9 | 13.9 | 3.9 | 3.9 | 3.9 |
| Citric Acid | 0.7 | 0.7 | 0.7 | 0.7 | 0.7 | 0.7 | 0.7 |
| Fatty acid | 10.7 | 10.8 | 10.8 | 10.7 | 10.8 | 10.8 | 10.8 |
| Chelants | 0.8 | 0.8 | 0.8 | 0.8 | 0.8 | 0.8 | 0.8 |
| Cleaning polymers | 3.2 | 3.2 | 3.2 | 3.2 | 3.2 | 3.2 | 3.2 |
| Cationically modified | — | — | — | 0.45 | 0.45 | 0.45 | 0.45 |
| hydroxyethyl cellulose* | | | | | | | |
| Enzymes | 0.05 | 0.05 | 0.05 | 0.05 | 0.05 | 0.05 | 0.05 |
| Structurant | 0.16 | 0.16 | 0.16 | 0.16 | 0.16 | 0.16 | 0.16 |
| Solvent system** | 23.5 | 21.6 | 21.3 | 23.5 | 21.6 | 21.3 | 21.7 |
| Water | 10.3 | 10.3 | 10.3 | 10.3 | 10.3 | 10.3 | 10.2 |
| Perfume | 1.7 | 1.7 | 1.7 | 1.7 | 1.7 | 1.7 | 1.7 |
| Perfume micro capsules | 0.63 | 0.63 | 0.63 | 0.63 | 0.63 | 0.63 | 0.63 |
| (expressed as % | | | | | | | |
| encapsulated oil) | | | | | | | |
| Mono-ethanolamine or | | | | | | | |
| NaOH (or mixture | | | | | | | |
| thereof) | | | | | | | |
| Other laundry | | | | | | | |
| adjuncts/minors | | | | | | | |

*If present, separated from enzymes through use of multi compartment pouch design.
**May include, but not limited to propanediol, glycerol, ethanol, dipropyleneglycol, polyetheyleneglycol, polypropyleneglycol.

28 g of formulations A to G, encapsulated in a PVA-film (mono compartment or multi compartment in case of presence of cationically modified hydroxy-ethyl cellulose), were washed (Miele W1714 short cotton cycle at 40° C., 2.5 mmol/L water hardness) together with terry and polyester tracers and 3.0 kg of mixed (cotton, poly-cotton, polyester) ballast load. After line drying, the terry fabric deposits were extracted with ethanol at 60° C. (2 hours on a lab shaker). The extracts were analyzed for perfume raw material deposition using large volume injection GC-MS analysis. Quantitation was performed by means of an internal standard calibration method, with tonalid as internal standard. Perfume deposition results below are expressed as μg deposited PRM/g fabric.

| Polyester fabric | A | B | C |
|---|---|---|---|
| Perfume deposition (μg deposited | REF | 150 | 140 |
| perfume raw material/g fabric) | (100) | | |
| index versus reference | | | |

| Cotton Fabric | D | E | F | G |
|---|---|---|---|---|
| Perfume deposition (μg deposited | REF | 240 | 320 | 340 |
| perfume raw material/g fabric) | (100) | | | |
| index versus reference | | | | |

Wet and dry (line-dried) terry tracers, included in the same wash, were subjected to headspace analysis. 5 replicates were analyzed by fast headspace GC/MS. 4×4 cm aliquots of the terry cotton tracers were transferred to 25 mL headspace vials. The fabric samples were equilibrated for 10 minutes at 75° C. The headspace above the fabrics was sampled via SPME (50/30 μm DVB/Carboxen/PDMS) approach for 5 minutes. The SPME fibre was subsequently on-line thermally desorbed into the GC. The analytes were analyzed by fast GC/MS in full scan mode. Ion extraction of the specific masses of the perfume raw materials were used to calculate the total headspace response (expressed in area counts) above the tested legs.

| | Headpsace analysis on wet fabrics (area counts) index |
|---|---|
| Formulation | versus reference |
| D | REF (100) |
| E | 170 |
| F | 140 |
| G | 170 |

| | Headpsace analysis on dry fabrics (area counts) index |
|---|---|
| Formulation | versus reference |
| D | REF (100) |
| E | 260 |
| F | 210 |
| G | 240 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble laundry unit dose article comprising a liquid composition, wherein said composition comprises;
an anionic surfactant;
a non-ionic surfactant;
water;
wherein the weight ratio of total anionic: non-ionic is between about 5:1 and about 23:1;
and wherein the composition comprises between about 0.1 wt % and about 5 wt % of a perfume and between about 0.1 wt % and about 5 wt % of an encapsulated perfume.

2. A unit dose article according to claim 1, wherein the anionic surfactant comprises linear alkylbenzene sulphonate.

3. A unit dose article according to claim 1, wherein the weight ratio of anionic to non-ionic surfactant is from about 5:1 to about 20:1.

4. A unit dose article according to claim 1, wherein the weight ratio of anionic to non-ionic surfactant is from about 5:1 to about 15:1.

5. A unit dose article according to claim 1, wherein the non-ionic surfactant comprises a fatty alcohol ethoxylate of formula R(EO)ₙ, wherein R represents an alkyl chain between about 4 and about 30 carbon atoms, (EO) represents one unit of ethylene oxide monomer and n has an average value between about 0.5 and about 20.

6. A unit dose article according to claim 1 wherein the anionic surfactant comprises fatty acid.

7. A unit dose article according to claim 1 comprising an cationic hydroxyethyl cellulose polymer, preferably a cationic hydroxyethyl cellulose polymer derivatised with trimethyl ammonium substituted epoxide.

8. A unit dose article according to claim 1, wherein the cationic polymer has a molecular weight of between about 100,000 and about 800,000 daltons.

9. A unit dose article according to claim 7 wherein the polymer is present at a level of between about 0.05% and about 2%, by weight of the composition.

10. A unit dose article according to claim 7 wherein the polymer is present at a level of between about 0.6% and about 1% by weight of the of composition.

11. A unit dose article according to claim 1 wherein the encapsulated perfume comprises a core material and a wall material that at least partially surrounds said core, wherein said core comprises the perfume.

12. A unit dose article according to claim 1 wherein the ratio of total surfactant to water is between about 3:1 to about 20:1.

13. A unit dose article according to claim 1 comprising between about 0.5 wt % and about 25 wt % water.

14. A unit dose article according to claim 1 comprising an adjunct laundry detergent ingredient, wherein the adjunct laundry detergent ingredient is selected from bleach, bleach catalyst, dye, hueing agents, cleaning polymers, alkoxylated polyamines, polyethyleneimines, alkoxylated polyethyleneimines, soil release polymers, amphiphilic graft polymers, surfactants, solvents, dye transfer inhibitors, chelants, enzymes, perfumes, encapsulated perfumes, perfume delivery agents, suds suppressor, brighteners, polycarboxylates, structurants, anti-oxidants, deposition aids and mixtures thereof.

15. A unit dose article according to claim 1 comprising at least two compartments.

16. A unit dose article according to claim 1 comprising at least three compartments.

17. The unit dose article according to claim 12 where the compartments are arranged in a superposed orientation or in a side-by-side orientation.
